(19) United States
(12) Patent Application Publication
(10) Pub. No.: US 2026/0340593 A1
(43) Pub. Date: Oct. 29, 2026

(54) DEVICE COMPONENT DURATION-RELATED ANALYSIS USING ARTIFICIAL INTELLIGENCE TECHNIQUES

(71) Applicant: Dell Products L.P., Round Rock, TX (US)

(72) Inventors: Sujit Kumar Sahoo, Bangalore (IN); Dhilip S. Kumar, Bangalore (IN)

(21) Appl. No.: 19/187,774

(22) Filed: Apr. 23, 2025

(51) Int. Cl. G06Q 10/20

(52) U.S. Cl. CPC G06Q 10/20

(57) ABSTRACT

Methods, apparatus, and processor-readable storage media for device component duration-related analysis using artificial intelligence techniques are provided herein. An example computer-implemented method includes obtaining multiple forms of data related to at least one device and multiple components of the at least one device; predicting remaining lifespan-related information for at least a portion of the multiple components by processing at least a portion of the multiple forms of data using one or more artificial intelligence techniques; determining at least one of the multiple components to be replaced within the at least one device based at least in part on the predicted remaining lifespan-related information; and performing one or more automated actions based at least in part on the at least one component determined to be replaced within the at least one device.

### BACKGROUND

When an electronics device reaches the end of its useful life, it is commonly disposed of, producing what is referred to as e-waste. For example, in conventional device management approaches, end-of-life electronic devices are often returned and/or provided by users to device producers for the exchange and/or purchase of a new and/or replacement device. The producers then often dispose of the returned device as e-waste, which can result in environmental damage related to any hazardous elements contained in the e-waste, and the incurrence of resource-intensive processes related to new device development, manufacturing, etc.

### SUMMARY

Illustrative embodiments of the disclosure provide techniques for device component duration-related analysis using artificial intelligence techniques.

An example computer-implemented method includes obtaining multiple forms of data related to at least one device and multiple components of the at least one device, and predicting remaining lifespan-related information for at least a portion of the multiple components by processing at least a portion of the multiple forms of data using one or more artificial intelligence techniques. The method also includes determining at least one of the multiple components to be replaced within the at least one device based at least in part on the predicted remaining lifespan-related information. Further, the method includes performing one or more automated actions based at least in part on the at least one component determined to be replaced within the at least one device.

Illustrative embodiments can provide significant advantages relative to conventional device management approaches. For example, problems associated with environmental damage and resource-intensive device replacement processes arising from e-waste are overcome in one or more embodiments through identifying, using artificial intelligence techniques, one or more components within a device to be replaced and automatically initiating component replacement operations in accordance therewith.

These and other illustrative embodiments described herein include, without limitation, methods, apparatus, systems, and computer program products comprising processor-readable storage media.

### BRIEF DESCRIPTION OF THE DRAWINGS

FIG. 1 shows an information processing system configured for device component duration-related analysis using artificial intelligence techniques in an illustrative embodiment.

FIG. 2 shows an example workflow in an illustrative embodiment.

FIG. 3 shows example system architecture in an illustrative embodiment.

FIG. 4 shows example network architecture of a bi-directional recurrent neural network (RNN) with a long short-term memory (LSTM) model in an illustrative embodiment.

FIG. 5 shows example system architecture of an intent classifier in an illustrative embodiment.

FIG. 6 shows an example intent table in an illustrative embodiment.

FIG. 7 is a flow diagram of a process for device component duration-related analysis using artificial intelligence techniques in an illustrative embodiment.

FIGS. 8 and 9 show examples of processing platforms that may be utilized to implement at least a portion of an information processing system in illustrative embodiments.

### DETAILED DESCRIPTION

Illustrative embodiments will be described herein with reference to example computer networks and associated computers, servers, network devices or other types of processing devices. It is to be appreciated, however, that these and other embodiments are not restricted to use with the particular illustrative network and device configurations shown. Accordingly, the term “computer network” as used herein is intended to be broadly construed, so as to encompass, for example, any system comprising multiple networked processing devices.

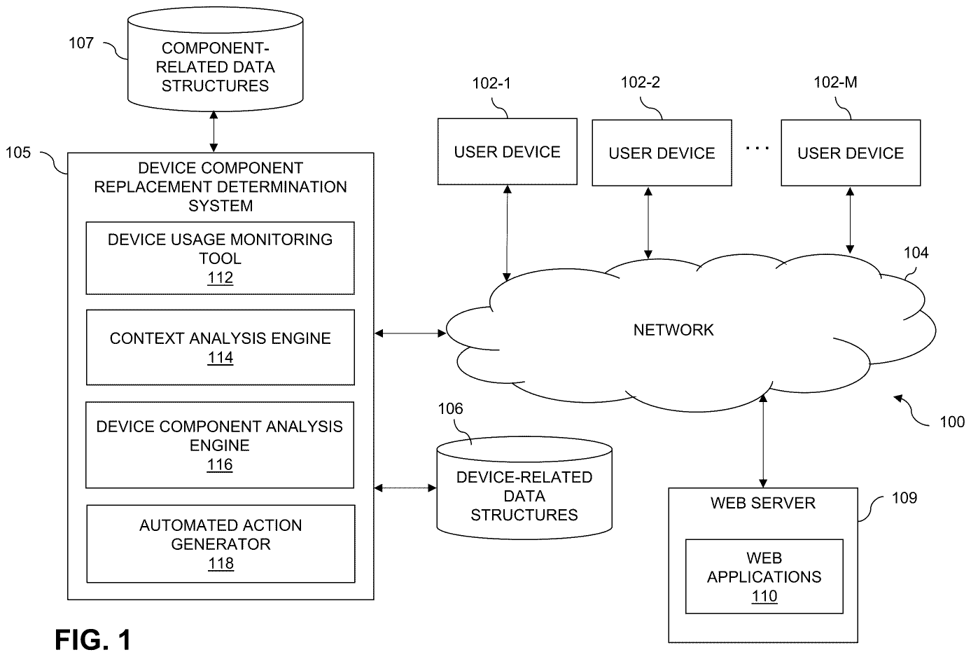

FIG. 1 shows a computer network (also referred to herein as an information processing system) 100 configured in accordance with an illustrative embodiment. The computer network 100 comprises a plurality of user devices 102-1, 102-2, . . . 102-M, collectively referred to herein as user devices 102. The user devices 102 are coupled to a network 104, where the network 104 in this embodiment is assumed to represent a sub-network or other related portion of the larger computer network 100. Accordingly, elements 100 and 104 are both referred to herein as examples of “networks” but the latter is assumed to be a component of the former in the context of the FIG. 1 embodiment. Also coupled to network 104 is device component replacement determination system 105 and web server 109, upon which one or more web applications 110 (e.g., e-commerce applications, device support applications, device management applications, etc.) execute.

The user devices 102 may comprise, for example, mobile telephones, laptop computers, tablet computers, desktop computers or other types of computing devices. Such devices are examples of what are more generally referred to herein as “processing devices.” Some of these processing devices are also generally referred to herein as “computers.”

The user devices 102 in some embodiments comprise respective computers associated with a particular company, organization or other enterprise. In addition, at least portions of the computer network 100 may also be referred to herein as collectively comprising an “enterprise network.” Numerous other operating scenarios involving a wide variety of different types and arrangements of processing devices and networks are possible, as will be appreciated by those skilled in the art.

Also, it is to be appreciated that the term “user” in this context and elsewhere herein is intended to be broadly construed so as to encompass, for example, human, hardware, software or firmware entities, as well as various combinations of such entities.

The network 104 is assumed to comprise a portion of a global computer network such as the Internet, although other types of networks can be part of the computer network 100, including a wide area network (WAN), a local area network (LAN), a satellite network, a telephone or cable network, a cellular network, a wireless network such as a Wi-Fi or WiMAX network, or various portions or combinations of these and other types of networks. The computer network 100 in some embodiments therefore comprises combinations of multiple different types of networks, each comprising processing devices configured to communicate using internet protocol (IP) or other related communication protocols.

Additionally, the device component replacement determination system 105 can have one or more device-related data structures 106 configured to store data pertaining to usage data, user feedback data, support inspection data, etc. associated with one or more devices. Also, as depicted in FIG. 1, the device component replacement determination system 105 can have one or more component-related data structures 107 configured to store data pertaining to usage data, user feedback data, support inspection data, etc. associated with various device components. The term “data structure,” as used herein, is intended to be broadly construed, so as to encompass, for example, a wide variety of different types of tables, arrays, graphs, trees, linked lists, and additional or alternative data relation mechanisms, as well as portions or combinations thereof. Accordingly, a given data structure can comprise a combination of multiple smaller data structures, possibly of different types, or a portion of a larger data structure. Numerous other arrangements are possible.

The device-related data structures 106 and/or component-related data structures 107 in the present embodiment are implemented using one or more storage systems associated with the device component replacement determination system 105. Such storage systems can comprise any of a variety of different types of storage including network-attached storage (NAS), storage area networks (SA Ns), direct-attached storage (DAS) and distributed DAS, as well as combinations of these and other storage types, including software-defined storage.

Also associated with the device component replacement determination system 105 are one or more input-output devices, which illustratively comprise keyboards, displays or other types of input-output devices in any combination. Such input-output devices can be used, for example, to support one or more user interfaces to the device component replacement determination system 105, as well as to support communication between the device component replacement determination system 105 and other related systems and devices not explicitly shown.

Additionally, the device component replacement determination system 105 in the FIG. 1 embodiment is assumed to be implemented using at least one processing device. Each such processing device generally comprises at least one processor and an associated memory, and implements one or more functional modules for controlling certain features of the device component replacement determination system 105.

More particularly, the device component replacement determination system 105 in this embodiment can comprise a processor coupled to a memory and a network interface.

The processor may comprise, for example, a microprocessor, an application-specific integrated circuit (A SIC), a system-on-chip (SOC), a field-programmable gate array (FPGA), a central processing unit (CPU), a graphics processing unit (GPU), a neural processing unit (NPU), a data processing unit (DPU), a tensor processing unit (TPU), an arithmetic logic unit (ALU), a digital signal processor (DSP), and/or other similar processing device components, as well as other types and arrangements of processing circuitry, in any combination. At least a portion of the functionality of at least one artificial intelligence system and its associated artificial intelligence algorithms provided by one or more processing devices as disclosed herein can be implemented using such circuitry.

The memory illustratively comprises random access memory (RAM), read-only memory (ROM) or other types of memory, in any combination. The memory and other memories disclosed herein may be viewed as examples of what are more generally referred to as “processor-readable storage media” storing executable computer program code or other types of software programs.

One or more embodiments include articles of manufacture, such as computer-readable storage media. Examples of an article of manufacture include, without limitation, a storage device such as a storage disk, a storage array or an integrated circuit containing memory, as well as a wide variety of other types of computer program products. The term “article of manufacture” as used herein should be understood to exclude transitory, propagating signals. These and other references to “disks” herein are intended to refer generally to storage devices, including solid-state drives (SSDs), and should therefore not be viewed as limited in any way to spinning magnetic media.

The network interface allows the device component replacement determination system 105 to communicate over the network 104 with the user devices 102, and illustratively comprises one or more conventional transceivers.

The device component replacement determination system 105 further comprises device usage monitoring tool 112, context analysis engine 114, device component analysis engine 116, and automated action generator 118.

In at least one embodiment, the device usage monitoring tool 112 obtains and/or processes various usage metrics and/or other related data associated with one or more devices and components thereof. Also, in such an embodiment, the context analysis engine 114 processes device and/or component usage data to determine and/or identify one or more components of a device that can be replaced. Additionally, the device component analysis engine 116 determines a device end of life extension recommendation based at least in part on the identified components in accordance with replacement preference. Further, in such an embodiment, the automated action generator 118 automatically initiates and/or executes one or more replacement actions in accordance with the device end of life extension recommendation.

It is to be appreciated that this particular arrangement of elements 112, 114, 116 and 118 illustrated in the device component replacement determination system 105 of the FIG. 1 embodiment is presented by way of example only, and alternative arrangements can be used in other embodiments. For example, the functionality associated with elements 112, 114, 116 and 118 in other embodiments can be combined into a single module, or separated across a larger number of modules. As another example, multiple distinct processors can be used to implement different ones of elements 112, 114, 116 and 118 or portions thereof.

At least portions of elements 112, 114, 116 and 118 may be implemented at least in part in the form of software that is stored in memory and executed by a processor.

It is to be understood that the particular set of elements shown in FIG. 1 for device component duration-related analysis using artificial intelligence techniques involving user devices 102 of computer network 100 is presented by way of illustrative example only, and in other embodiments additional or alternative elements may be used. Thus, another embodiment includes additional or alternative systems, devices and other network entities, as well as different arrangements of modules and other components. For example, in at least one embodiment, two or more of device component replacement determination system 105, device-related data structures 106, component-related data structures 107, and web server 109 can be on and/or part of the same processing platform.

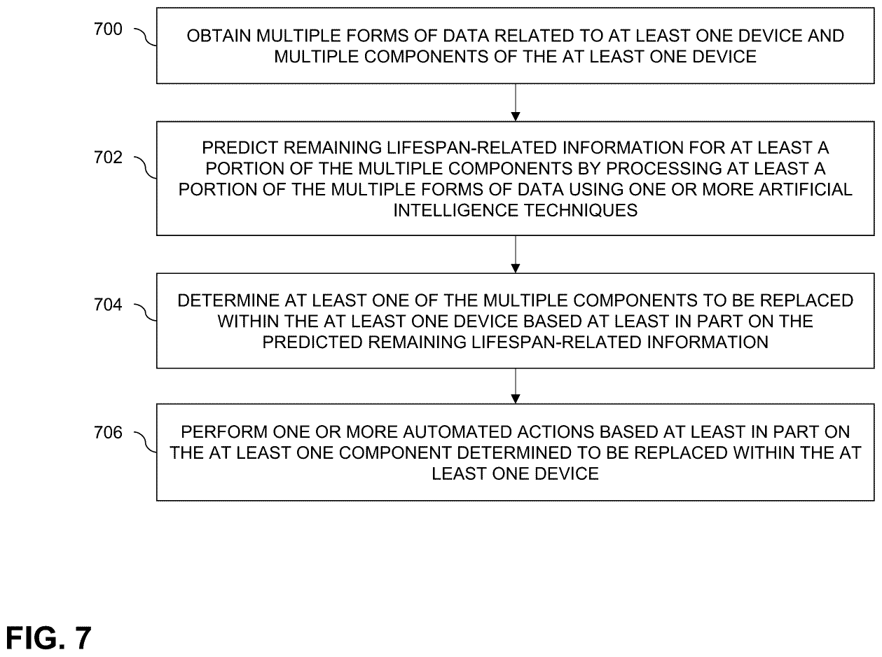

An example process utilizing elements 112, 114, 116 and 118 of an example device component replacement determination system 105 in computer network 100 will be described in more detail with reference to the flow diagram of FIG. 7.

Accordingly, at least one embodiment includes device component duration-related analysis using artificial intelligence techniques. As further detailed herein, such an embodiment can include extending the end-of-life for electronic devices and/or components thereof to reduce environmental harm associated with e-waste and enhance resource-intensive processes associated with device development and/or replacement.

Accordingly, at least one embodiment includes using artificial intelligence techniques to identify one or more components of a device (e.g., the one or more weakest components) that could cause and/or lead to device failure within a given temporal period. For example, such an embodiment can include using artificial intelligence-based compatibility analysis to process device and/or component usage data to identify, as replacement candidates, one or more device components nearing their end of life. In such an embodiment, for a given device, details of the device and components thereof are available in at least one corresponding component store. For a component approaching end of life, there will be alternative components and corresponding master data which provides information whether the alternate components are compatible to the given device. Usage data can include, e.g., system logs, which provide information about system events including the failure of different components.

Further, one or more embodiments can include initiating one or more automated actions related to replacing the one or more identified components, thereby extending the device's life and reducing the creation of e-waste.

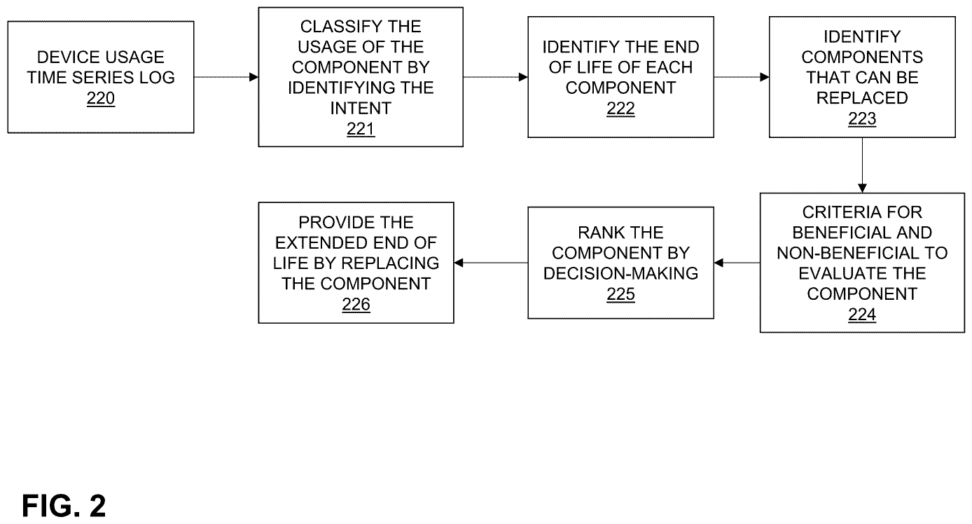

FIG. 2 shows an example workflow in an illustrative embodiment. By way of illustration, step 221 includes classifying the usage of each of multiple device components by identifying one or more intents in connection with processing device usage time series log data 220. Further, step 222 includes determining and/or identifying the end of life for each of the device components, and based at least in part thereon, step 223 includes identifying one or more of the device components that can be replaced in accordance with one or more rules (e.g., a deviation matrix of the component for a particular platform and/or device). Additionally, step 224 includes determining beneficial and non-beneficial criteria (e.g., results of an engineering test cycle when a new component is introduced) for evaluating the one or more identified device components, and step 225 includes ranking the one or more identified device components using multi-criteria decision making techniques in connection with the determined criteria. Further, step 226 includes providing an extension to the end of life of the device in question by replacing at least one of the one or more identified device components in accordance with the ranking.

One or more embodiments include leveraging one or more agents and/or other monitoring tools to generate and/or obtain logs pertaining to the usage and/or health of a given device and/or one or more components thereof. Additionally, such an embodiment can include processing at least a portion of the data contained in such logs using one or more artificial intelligence techniques to determine and/or predict the end-of-life for at least one of the one or more device components and to recommend the at least one device component be replaced to extend the end-of-life of the entire device. In at least one example embodiment, such determinations and/or predictions can be carried out using multi-criteria decision making, in connection with the one or more artificial intelligence techniques, to determine a desirable result pertaining to each given device component by considering multiple component-related aspects such as, e.g., cost of replacing the component, end-of-life information pertaining to the replacement component, availability of the component, supportability of the device, etc.

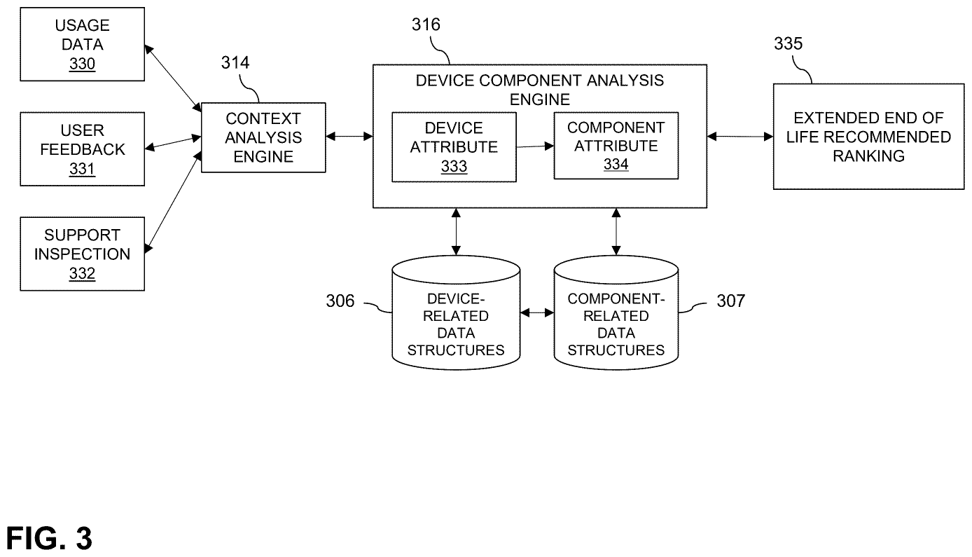

FIG. 3 shows example system architecture in an illustrative embodiment. By way of illustration, FIG. 3 depicts device usage data 330, user feedback data 331 and support inspection data 332, at least portions of which are processed by context analysis engine 314 to determine and/or identify one or more components of the device that can be replaced. Additionally, FIG. 3 also depicts device component analysis engine 316, which determines, based at least in part on the outputs of the context analysis engine 314 and on data from device-related data structures 306 and component-related data structures 307, one or more device attributes 333 and one or more component attributes 334 for each of the one or more identified components. Based at least on one or more of the determined attributes 333 and 334, device component analysis engine 316 can also determine and output a device end of life extension recommendation ranking 335, which includes a ranking of the one or more identified components in accordance with replacement preference.

More particularly, context analysis engine 314 processes device usage data 330, user feedback data 331 and support inspection data 332 to determine one or more components of the given device that are replaceable and/or should be replaced within a given temporal duration. In an example embodiment wherein at least a portion of the above-noted data is in a text format, the context analysis engine 314 can process such data using one or more natural language understanding (NLU) techniques and/or one or more neural networks to analyze the text data and classify one or more intents (e.g., the categorization of the support issue and/or feedback when a user raises a support request and/or provides feedback against a device) within the text data.

By way of example, such an embodiment can include using at least one RNN to process such data. M ore particularly, and as further detailed herein, at least one embodiment can include using a bi-directional RNN, which uses two separate processing sequences, one from left to right and another from right to left. Further still, one or more embodiments can include using a bi-directional RNN with a long short-term memory (LSTM) model in connection with one or more NLU techniques.

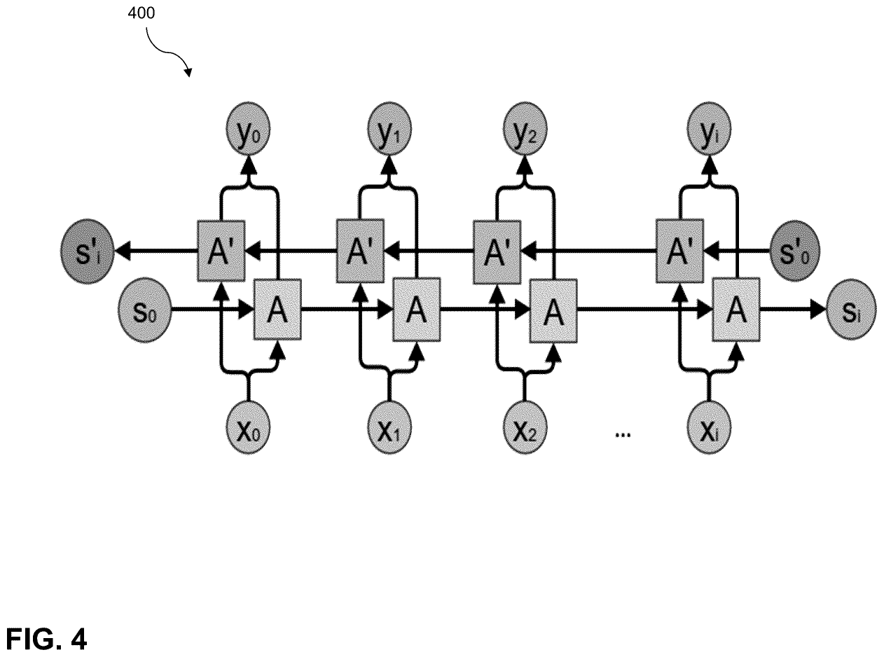

FIG. 4 shows example network architecture of an example bi-directional RNN with an LSTM model 400 in an illustrative embodiment. By way of illustration, the example bi-directional RNN with an LSTM model 400 includes an input layer which includes x₀, x₁, x₂, and xᵢ, a bi-directional layer which includes s′ᵢ, s′₀, s′₀, sᵢ, A, and A′, and an output layer which includes y₀, y₁, y₂, yᵢ. In such an example illustration, s refers to an availability date of the given component, s′ refers to an availability date of an alternate component, A refers to availability quantity of the given component, A′ refers to availability quantity of an alternate component, x refers to an input, and y refers to an output.

As detailed herein, RNNs represent a type of neural network wherein the previous step's output feeds into the current step's input. In a traditional neural network, also referred to as a feed-forward network, input and output are independent. In language processing, it is often important to remember the previous word(s) before predicting the next term of a sentence or other language sequence. Accordingly, a RNN can enhance such processing by having a hidden state recognize one or more phrases in the sentence or language sequence. For example, if the sentence is too long, some of the previous information may not be available in the limited hidden state, which requires the bi-directional processing of the sentence (from past and future in two sequences parallelly), as done when using a bi-directional RNN, such as used in one or more embodiments. Additionally, in at least one embodiment, incorporating LSTM introduces one or more advanced memory units and gates to the RNN, which can improve the model's accuracy and performance.

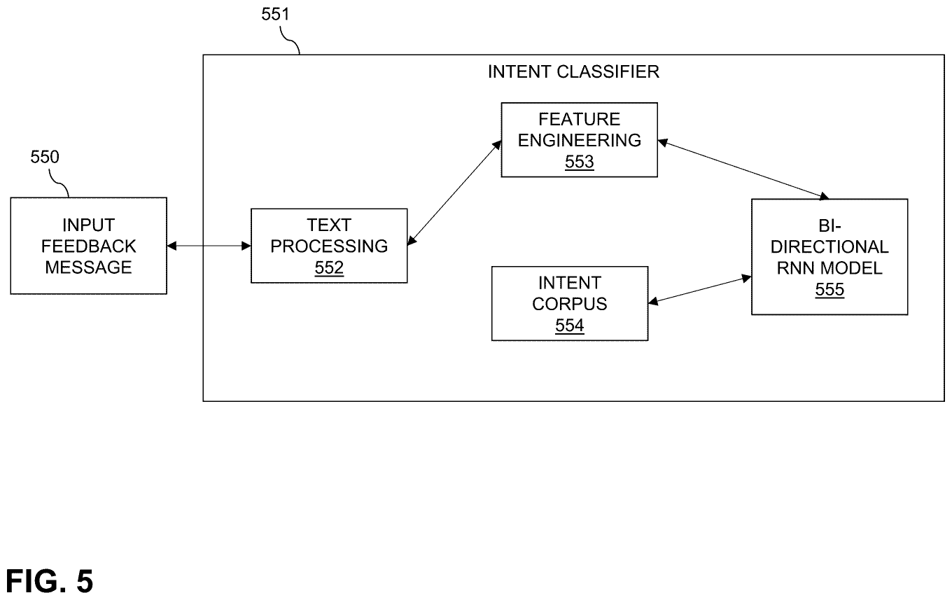

FIG. 5 shows example system architecture of an intent classifier in an illustrative embodiment. By way of illustration, FIG. 5 depicts a conversational intent analysis, carried out by intent classifier 551, which includes using at least one set of intent corpus data 554 to train bi-directional RNN model 555, wherein such intent corpus data 554 contains words and/or phrases as well as the intent associated with each of multiple training sentences. In at least one embodiment, at least a portion of the at least one set of intent corpus data 554 is preprocessed to clean any unwanted characters and/or stop words. Such preprocessing can also include stemming and lemmatization, changing text to lowercase letters, removing punctuation, etc.

Once preprocessing is complete, an input list of words (e.g., in an input sentence) is tokenized. In one or more embodiments, tokenizing the words can include using at least one K eras library, at least one natural language toolkit (NLTK) library, etc. For example, a K eras tokenizer class can be used to index the tokens, and after tokenization is completed, the tokens can be padded to render the tokens of equal length to be used by the bi-directional RNN model 555.

For output encoding, tokenization and padding of the corpus' intent list is carried out. Subsequently, the intent list is indexed and prepared to be fed into the bi-directional RNN model 555. As part of this process, the intent list can be one-hot encoded before being provided to the bi-directional RNN model 555. Accordingly, in such an embodiment, the at least one set of intent corpus data 554 is used to train the bi-directional RNN model 555 before using the bi-directional RNN model 555 to predict at least one intent for an input feedback message 550, in connection with text processing 552 and feature engineering 553 applied to at least a portion of the input feedback message 550 prior to processing by the bi-directional RNN model 555.

In one or more embodiments, the bi-directional RNN model with LSTM is created using the Keras library. One or more parameters are passed during the creation of the bi-directional RNN model, including, for example, an adaptive moment estimation (A dam) optimizer algorithm, a Softmax activation function, batch size and periods, a designated number of epochs, etc. Such parameters can be tuned to improve performance and accuracy of the bi-directional RNN model. After the bi-directional RNN model is trained with the intent training data, the model can be used to predict an incoming and/or input message's intent.

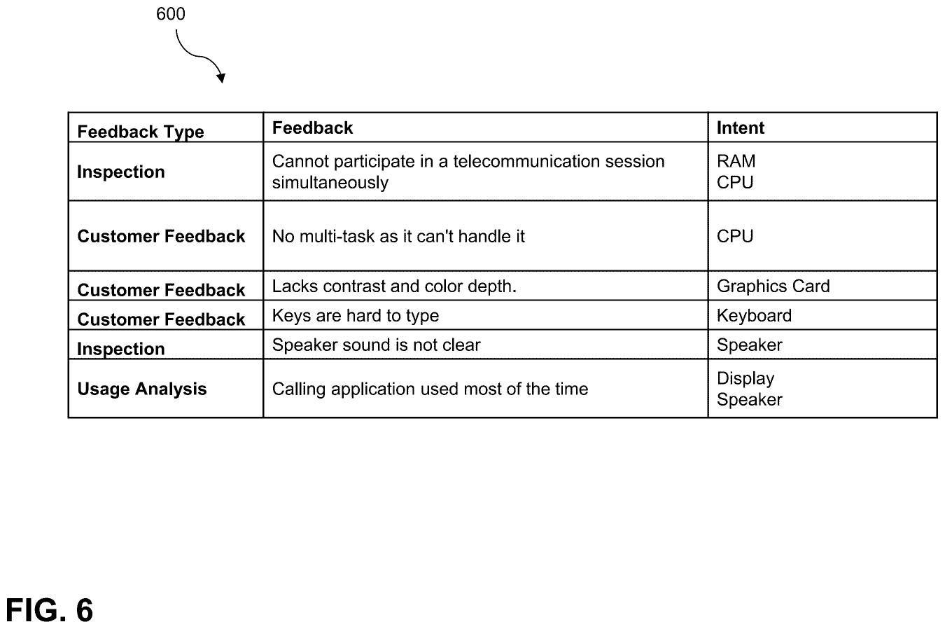

FIG. 6 shows an example intent table 600 in an illustrative embodiment. By way of illustration, example intent table 600 includes columns directed to data associated with feedback type, corresponding user feedback, and the intent in question (e.g., the device component(s) associated with the feedback).

As detailed herein, the determined intent of input data can be leveraged in identifying one or more device components to be replaced in connection with end-of-life data. By tokenizing the motive, the context and/or intent can be determined. Based at least in part on intent analysis associated with multiple device components, the ranking of the device components can be calculated. As further described below, such a calculation can include taking the device components, C=[c₁, c₂, c₃, . . . cₙ], and alternate device components,

$${C}^{′} = [ {c}_{1}^{′} , {c}_{2}^{′} , {c}_{3}^{′} , … {c}_{n}^{′} ] ,$$

and normalizing their attributes in furtherance of ranking of the device components on the basis of needing to be replaced and/or proximity to end-of-life.

In one or more embodiments (such as depicted in connection, for example, with FIG. 1 and FIG. 3), component analysis is carried out in connection with identifying available components for a device in question. Such component analysis can include leveraging certain device data (e.g., device usage data, device health data, etc.) and its component data (e.g., component usage data, component health data, etc.). For example, leveraging such data can facilitate identifying a given device component and its availability, cost and/or compatibility. If the component is not compatible with a given device, the component analysis recommendation system cannot be extended. Based at least in part on such analysis, information pertaining to components that can be used for replacement as well as information pertaining to components that cannot be used for replacement are added to one or more device component-related data structure, along with corresponding information pertaining to features such as cost, end-of-life data, etc.

For a given a list of components C=[c₁, c₂, c₃, . . . cₙ], at least one embodiment includes identifying the component having the earliest end-of-life date (min(C)), and that min(C) component can be associated with a list of compatible alternate components

$${C}^{′} = [ {c}_{1}^{′} , {c}_{2}^{′} , {c}_{3}^{′} , … {c}_{n}^{′} ] .$$

Additionally, in such an embodiment, each alternate component from list C′ can have the following attributes: End-of-life date=dtᵢ; Cost=pᵢ; Brand=bᵢ; Brand Rank=br; Supportable date=sᵢ. Such attributes can be derived values from one or more data sources such as, e.g., e-commerce site feedback sentiment analyses.

As further detailed herein, based at least in part on such alternate components, a recommendation engine can process the list of alternate components C′ and generate at least one recommendation.

For example, one or more embodiments (such as detailed in connection with FIG. 3, for example) include implementing multi-criteria decision making techniques to determine the best alternative component by considering more than one criterion (e.g., end-of-life, cost, brand, supportability, availability, etc.) in the selection process.

By way of illustration, such an embodiment can include performing component cost rank and normalization, wherein more weightage is given to the component having a lower cost, and the alternate components can be ranked in descending order in accordance with corresponding cost. In such an embodiment, let P=[p₁, p₂, . . . , pₙ] denote the list of n prices of the alternate components. The prices can then be sorted and/or arranged in descending order: p₁≥p₂≥ . . . ≥pₙ, and the rank of the price pᵢ can be defined as the position of pᵢ in the sorted list P: rank (pᵢ)=position of pᵢ in the sorted list P. The cost rank can then be normalized, for example, using Equation (1) below, which ensures that the ranking is normalized between 0 and 1:

$${p}_{i}^{′} = \frac{{p}_{i} - min ( rank ( {p}_{i} ) )}{max ( rank ( {p}_{i} ) ) - min ( rank ( {p}_{i} ) )} \qquad ( 1 )$$

One or more embodiments can also include ranking and normalizing alternate components by end-of-life date. In such an embodiment, let D=[dt₁, dt₂, dt₃, . . . dtₙ] denote the list of n end-of-life dates. Also, such an embodiment can include assigning a greater weight to the components with the latest end-of-life dates, and then sorting and/or arranging the end-of-life dates in ascending order: dt₁≤dt₂≤ . . . ≤dtₙ. The rank of the date dt; can be defined as the position of dtᵢ in the sorted list D: rank (dtᵢ)=position of dt in the sorted list D. The end-of-life date rank can then be normalized, for example, using Equation (2) below, which ensures that the ranking is normalized between 0 and 1:

$${dt}_{i}^{′} = \frac{{dt}_{i} - min ( rank ( {dt}_{i} ) )}{max ( rank ( {dt}_{i} ) ) - min ( rank ( {dt}_{i} ) )} \qquad ( 2 )$$

Additionally, one or more embodiments can also include ranking and normalizing alternate components by availability. Such an embodiment can include assigning a higher weight to alternate components with higher quantities of available resources. Further, in such an embodiment, let A=[a₁, a₂, . . . , aₙ] denote the list of n availability quantities of the alternate components. The alternate components can then be sorted and/or arranged in ascending order by available quantity: a₁≤a₂≤ . . . , ≤aₙ, and the rank of the available quantity aᵢ can be defined as the position of aᵢ in the sorted list A: rank(aᵢ)=position of at in the sorted list A. The availability rank can then be normalized, for example, using Equation (3) below, which ensures that the ranking is normalized between 0 and 1:

$${a}_{i}^{′} = \frac{{a}_{i} - min ( rank ( {a}_{i} ) )}{max ( rank ( {a}_{i} ) ) - min ( rank ( {a}_{i} ) )} \qquad ( 3 )$$

At least one embodiment can also include ranking and normalizing alternate components by supportable date. In such an embodiment, let S=[s₁, s₂, s₃, . . . sₙ] denote the list of n supportable dates. Such an embodiment can also include assigning a greater weight to the components that have the latest supportable date, and sorting and/or arranging the supportable dates in ascending order: s₁≤s₂≤ . . . ≤sₙ. The rank of the supportable dates; can be defined as the position of sᵢ in the sorted list S: rank(sᵢ)=position of sᵢ in the sorted list S. The supportable date can then be normalized, for example, using Equation (4) below, which ensures that the ranking is normalized between 0 and 1:

$${s}_{i}^{′} = \frac{{s}_{i} - min ( rank ( {s}_{i} ) )}{max ( rank ( {s}_{i} ) ) - min ( rank ( {s}_{i} ) )} \qquad ( 4 )$$

Also, one or more embodiments can include ranking and normalizing alternate components by brand value. In such an embodiment, let B=[b₁, b₂, b₃, . . . bₙ] denote the list of brand value ratings collected from one or more e-commerce sites. Such an embodiment can also include assigning a greater weight to the alternate components that are associated with brands having a higher rating and sorting and/or arranging the brand values in ascending order: b₁≤b₂≤ . . . ≤bₙ. The rank of the alternate component brand value bᵢ can be defined as the position of bᵢ in the sorted list B: rank (bᵢ)=position of bᵢ in the sorted list B. The brand value can then be normalized, for example, using Equation (5) below, which ensures that the ranking is normalized between 0 and 1:

$${b}_{i}^{′} = \frac{{b}_{i} - min ( rank ( {b}_{i} ) )}{max ( rank ( {b}_{i} ) ) - min ( rank ( {b}_{i} ) )} \qquad ( 5 )$$

One or more embodiments can also include generating an overall ranking of the alternate components, considering a plurality of attributes such as the examples detailed above. Also, such an embodiment can include adding dynamic weightage to each attribute to infer preference and/or importance to one or more of the attributes relative to the other attributes. By way of example, ωₚ can represent the weight for component cost attribute, ω_{d} can represent the weight for the component end-of-life attribute, ωₐ can represent the weight for the component availability attribute, ωₛ can represent the weight for the component supportable date attribute, and @ can represent the weight for the component brand rank attribute.

Additionally, based at least in part on the attribute calculations and the dynamic weights applied thereto, one or more embodiments include making one or more final attributes selection. In an example embodiment, all attributes are within the range of 0 to 1, which facilitates the computation of points of each attribute and determination of the one or more alternate components associated with the highest number of points. M ore particularly, in at least one embodiment, the total number of points for a given alternate component, acᵢ, can be calculated using Equation (6) as follows:

$${ac}_{i} = ( \frac{{ω}_{p} * {p}_{i}^{′} + {ω}_{d} * {dt}_{i}^{′} + {ω}_{a} * {a}_{i}^{′} + {ω}_{s} * {s}_{i}^{′} + {ω}_{b} * {b}_{i}^{′}}{{ω}_{p} + {ω}_{d} + {ω}_{a} + {ω}_{s} + {ω}_{b}} ) \qquad ( 6 )$$

Further, in such an embodiment, the best alternate component can be determined as the component with the highest number of points accumulated, determined using Equation (7) as follows:

$$Ac = {max}_{i : {N}_{i} ∈ {{C}^{′}}_{j}} {ac}_{i} \qquad ( 7 )$$

wherein C′ⱼ represents the list of all of the alternate components under consideration, and wherein Nᵢ represents an individual alternate component.

By way merely of illustration and example, consider a scenario wherein a CPU component is being analyzed. In such a scenario, one or more embodiments can include categorizing various CPU attributes as either beneficial criteria or non-beneficial criteria. Non-beneficial criteria can include attributes wherein lower values are desired (e.g., cost), and beneficial criteria can include attributes wherein higher values are desired (e.g., end-of-life date, brand value, supportability, availability, etc.). Additionally, in such an example embodiment, for beneficial criteria, each cell can be subdivided by performance value and maximum cell value, whereas for non-beneficial criteria, the minimum value can be taken and subtracted from the minimum cell value. One or more embodiments can also include solving such computations using at least one normalized decision matrix.

Such an embodiment can also include assigning weightage values to the attributes, wherein the total weightage should equal and/or add up to 100%. For example, consider a use case wherein equal weightage is assigned across all attributes (both non-beneficial criteria and beneficial criteria). By applying the weightage to each cell value, one or more embodiments include generating updated values, and ultimately generating a weightage-normalized decision matrix. The values can then be added together to determine the performance value for each alternate CPU component. Based at least in part on such multi-attribute decision-making computations, a particular alternate CPU component for the device in question can be recommended for replacement. Further, in at least one embodiment, one or more automated actions related to automatically replacing the CPU in the device with the recommended CPU can be initiated and/or carried out in connection with one or more related systems.

FIG. 7 is a flow diagram of a process for device component duration-related analysis using artificial intelligence techniques in an illustrative embodiment. It is to be understood that this particular process is only an example, and additional or alternative processes can be carried out in other embodiments.

In this embodiment, the process includes steps 700 through 706. These steps are assumed to be performed by the device component replacement determination system 105 utilizing elements 112, 114, 116 and 118.

Step 700 includes obtaining multiple forms of data related to at least one device and multiple components of the at least one device. In at least one embodiment, obtaining multiple forms of data includes obtaining two or more of device usage data, component usage data, user feedback data, support inspection data, device health-related data and component health-related data.

Step 702 includes predicting remaining lifespan-related information for at least a portion of the multiple components by processing at least a portion of the multiple forms of data using one or more artificial intelligence techniques. In one or more embodiments, predicting remaining lifespan-related information for the at least a portion of the multiple components includes processing the at least a portion of the multiple forms of data using at least one a bi-directional RNN with at least one LSTM model. Additionally or alternatively, predicting remaining lifespan-related information for the at least a portion of the multiple components can include classifying usage associated with the at least a portion of the multiple components by processing text data from the multiple forms of data using one or more NLU techniques.

Step 704 includes determining at least one of the multiple components to be replaced within the at least one device based at least in part on the predicted remaining lifespan-related information. In at least one embodiment, determining the at least one component to be replaced within the at least one device includes predicting a respective end-of-life date for each of the multiple components and identifying the at least one of the multiple components having the earliest end-of-life date. Additionally or alternatively, determining the at least one component to be replaced within the at least one device can include identifying one or more replacement component candidates for the at least one determined component to be replaced based at least in part on replacement component availability, replacement component cost and replacement component compatibility with the at least one device. Also, in at least one embodiment, determining the at least one component to be replaced within the at least one device includes ranking the multiple components based at least in part on predicted end-of-life date for each component, replacement component availability information for each component, replacement component cost information for each component, and replacement component compatibility with the at least one device information for each component.

Step 706 includes performing one or more automated actions based at least in part on the at least one component determined to be replaced within the at least one device. In one or more embodiments, performing one or more automated actions includes automatically initiating replacement of the at least one component determined to be replaced with at least one replacement component. In such an embodiment, performing one or more automated actions can include automatically extending remaining lifespan of the at least one device in connection with automatically initiating replacement of the at least one component determined to be replaced with the at least one replacement component. Further, in one or more embodiments, performing one or more automated actions includes automatically training at least a portion of the one or more artificial intelligence techniques based at least in part on feedback data related to the at least one component determined to be replaced within the at least one device.

Accordingly, the particular processing operations and other functionality described in conjunction with the flow diagram of FIG. 7 are presented by way of illustrative example only, and should not be construed as limiting the scope of the disclosure in any way. For example, the ordering of the process steps may be varied in other embodiments, or certain steps may be performed concurrently with one another rather than serially.

The above-described illustrative embodiments provide significant advantages relative to conventional approaches. For example, some embodiments are configured to identify, using artificial intelligence techniques, one or more components within a device to be replaced and automatically initiate component replacement operations in accordance therewith. These and other embodiments can effectively overcome problems associated with environmental damage and resource-intensive device replacement processes arising from e-waste.

It is to be appreciated that the particular advantages described above and elsewhere herein are associated with particular illustrative embodiments and need not be present in other embodiments. Also, the particular types of information processing system features and functionality as illustrated in the drawings and described above are examples only, and numerous other arrangements may be used in other embodiments.

As mentioned previously, at least portions of the information processing system 100 can be implemented using one or more processing platforms. A given processing platform comprises at least one processing device comprising a processor coupled to a memory. The processor and memory in some embodiments comprise respective processor and memory elements of a virtual machine or container provided using one or more underlying physical machines. The term “processing device” as used herein is intended to be broadly construed so as to encompass a wide variety of different arrangements of physical processors, memories and other device components as well as virtual instances of such components. For example, a “processing device” in some embodiments can comprise or be executed across one or more virtual processors. Processing devices can therefore be physical or virtual and can be executed across one or more physical or virtual processors. It should also be noted that a given virtual device can be mapped to a portion of a physical one.

Some illustrative embodiments of a processing platform used to implement at least a portion of an information processing system comprises cloud infrastructure including virtual machines implemented using a hypervisor that runs on physical infrastructure. The cloud infrastructure further comprises sets of applications running on respective ones of the virtual machines under the control of the hypervisor. It is also possible to use multiple hypervisors each providing a set of virtual machines using at least one underlying physical machine. Different sets of virtual machines provided by one or more hypervisors may be utilized in configuring multiple instances of various components of the system.

These and other types of cloud infrastructure can be used to provide what is also referred to herein as a multi-tenant environment. One or more system components, or portions thereof, are illustratively implemented for use by tenants of such a multi-tenant environment.

As mentioned previously, cloud infrastructure as disclosed herein can include cloud-based systems. Virtual machines provided in such systems can be used to implement at least portions of a computer system in illustrative embodiments.

In some embodiments, the cloud infrastructure additionally or alternatively comprises a plurality of containers implemented using container host devices. For example, as detailed herein, a given container of cloud infrastructure illustratively comprises a Docker container or other type of Linux Container (LXC). The containers are run on virtual machines in a multi-tenant environment, although other arrangements are possible. The containers are utilized to implement a variety of different types of functionality within the system 100. For example, containers can be used to implement respective processing devices providing compute and/or storage services of a cloud-based system. Again, containers may be used in combination with other virtualization infrastructure such as virtual machines implemented using a hypervisor.

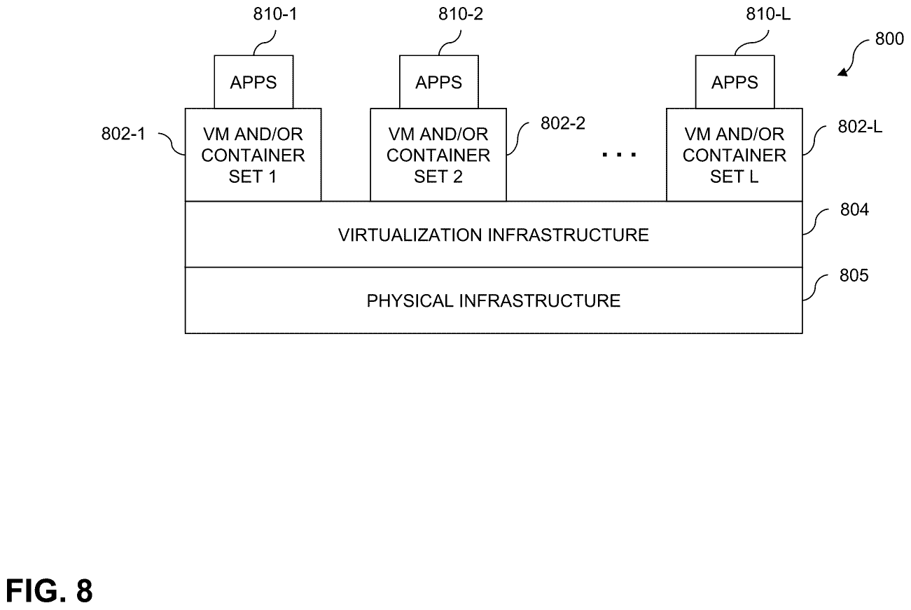

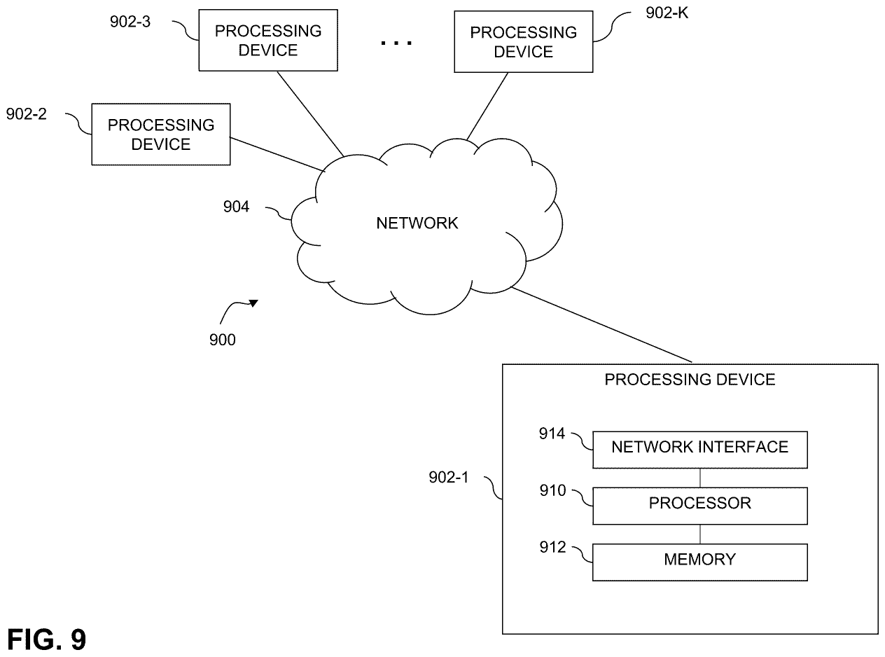

Illustrative embodiments of processing platforms will now be described in greater detail with reference to FIGS. 8 and 9. Although described in the context of system 100, these platforms may also be used to implement at least portions of other information processing systems in other embodiments.

FIG. 8 shows an example processing platform comprising cloud infrastructure 800. The cloud infrastructure 800 comprises a combination of physical and virtual processing resources that are utilized to implement at least a portion of the information processing system 100. The cloud infrastructure 800 comprises multiple virtual machines (VMs) and/or container sets 802-1, 802-2, . . . 802-L implemented using virtualization infrastructure 804. The virtualization infrastructure 804 runs on physical infrastructure 805, and illustratively comprises one or more hypervisors and/or operating system level virtualization infrastructure. The operating system level virtualization infrastructure illustratively comprises kernel control groups of a Linux operating system or other type of operating system.

The cloud infrastructure 800 further comprises sets of applications 810-1, 810-2, . . . 810-L running on respective ones of the VMs/container sets 802-1, 802-2, . . . 802-L under the control of the virtualization infrastructure 804. The VMs/container sets 802 comprise respective VMs, respective sets of one or more containers, or respective sets of one or more containers running in VMs. In some implementations of the FIG. 8 embodiment, the VMs/container sets 802 comprise respective VMs implemented using virtualization infrastructure 804 that comprises at least one hypervisor.

A hypervisor platform may be used to implement a hypervisor within the virtualization infrastructure 804, wherein the hypervisor platform has an associated virtual infrastructure management system. The underlying physical machines comprise one or more information processing platforms that include one or more storage systems.

In other implementations of the FIG. 8 embodiment, the VMs/container sets 802 comprise respective containers implemented using virtualization infrastructure 804 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of system 100 may each run on a computer, server, storage device or other processing platform element. A given such element is viewed as an example of what is more generally referred to herein as a “processing device.” The cloud infrastructure 800 shown in FIG. 8 may represent at least a portion of one processing platform. Another example of such a processing platform is processing platform 900 shown in FIG. 9.

The processing platform 900 in this embodiment comprises a portion of system 100 and includes a plurality of processing devices, denoted 902-1, 902-2, 902-3, . . . 902-K, which communicate with one another over a network 904.

The network 904 comprises any type of network, including by way of example a global computer network such as the Internet, a WAN, a LAN, a satellite network, a telephone or cable network, a cellular network, a wireless network such as a Wi-Fi or WiMAX network, or various portions or combinations of these and other types of networks.

The processing device 902-1 in the processing platform 900 comprises a processor 910 coupled to a memory 912.

The processor 910 comprises a microprocessor, an ASIC, an SOC, an FPGA, a CPU, a GPU, an NPU, a DPU, a TPU, an ALU, a DSP, and/or other similar processing device components, as well as other types and arrangements of processing circuitry, in any combination. At least a portion of the functionality of at least one artificial intelligence system and its associated artificial intelligence algorithms provided by one or more processing devices as disclosed herein can be implemented using such circuitry.

The memory 912 comprises RAM, ROM or other types of memory, in any combination. The memory 912 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture comprises, for example, a storage array, a storage disk or an integrated circuit containing RAM, ROM or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 902-1 is network interface circuitry 914, which is used to interface the processing device with the network 904 and other system components, and may comprise conventional transceivers.

The other processing devices 902 of the processing platform 900 are assumed to be configured in a manner similar to that shown for processing device 902-1 in the figure.

A gain, the particular processing platform 900 shown in the figure is presented by way of example only, and system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise different types of virtualization infrastructure, in place of or in addition to virtualization infrastructure comprising virtual machines. Such virtualization infrastructure illustratively includes container-based virtualization infrastructure configured to provide Docker containers or other types of LX Cs.

As another example, portions of a given processing platform in some embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

Also, numerous other arrangements of computers, servers, storage products or devices, or other components are possible in the information processing system 100. Such components can communicate with other elements of the information processing system 100 over any type of network or other communication media.

For example, particular types of storage products that can be used in implementing a given storage system of an information processing system in an illustrative embodiment include all-flash and hybrid flash storage arrays, scale-out all-flash storage arrays, scale-out NAS clusters, or other types of storage arrays. Combinations of multiple ones of these and other storage products can also be used in implementing a given storage system in an illustrative embodiment.

It should again be emphasized that the above-described embodiments are presented for purposes of illustration only. Many variations and other alternative embodiments may be used. Also, the particular configurations of system and device elements and associated processing operations illustratively shown in the drawings can be varied in other embodiments. Thus, for example, the particular types of processing devices, modules, systems and resources deployed in a given embodiment and their respective configurations may be varied. Moreover, the various assumptions made above in the course of describing the illustrative embodiments should also be viewed as examples rather than as requirements or limitations of the disclosure. Numerous other alternative embodiments within the scope of the appended claims will be readily apparent to those skilled in the art.

1. A computer-implemented method comprising:
obtaining multiple forms of data related to at least one device and multiple components of the at least one device;
predicting, in a machine learning system, remaining lifespan-related information for at least a portion of the multiple components by processing at least a portion of the multiple forms of data, the machine learning system comprising a processing pipeline that includes a natural language understanding (NLU) model and a bi-directional recurrent neural network (RNN), with an output, comprising tokenized elements derived from the at least a portion of the multiple forms of data, of the NLU model coupled to an input of the bi-directional RNN, wherein the bi-directional RNN comprises a long short-term memory (LSTM) model implementing one or more memory units and one or more gates in the bi-directional RNN in connection with processing the tokenized elements to predict the remaining lifespan-related information;
determining at least one of the multiple components to be replaced within the at least one device based at least in part on the predicted remaining lifespan-related information; and
performing one or more automated actions related to automatically replacing, in connection with one or more additional systems, the at least one component determined to be replaced within the at least one device;
wherein the method is performed by at least one processing device comprising a processor coupled to a memory.

2. (canceled)

3. The computer-implemented method of claim 1, wherein determining the at least one component to be replaced within the at least one device comprises predicting a respective end-of-life date for each of the multiple components and identifying at least one of the multiple components having the earliest end-of-life date.

4. The computer-implemented method of claim 1, wherein determining the at least one component to be replaced within the at least one device comprises identifying one or more replacement component candidates for the at least one determined component to be replaced based at least in part on replacement component availability, replacement component cost and replacement component compatibility with the at least one device.

5. The computer-implemented method of claim 1, wherein performing one or more automated actions comprises automatically initiating replacement of the at least one component determined to be replaced with at least one replacement component.

6. The computer-implemented method of claim 5, wherein performing one or more automated actions comprises automatically extending remaining lifespan of the at least one device in connection with automatically initiating replacement of the at least one component determined to be replaced with the at least one replacement component.

7. The computer-implemented method of claim 1, wherein predicting remaining lifespan-related information for the at least a portion of the multiple components comprises classifying usage associated with the at least a portion of the multiple components by processing text data from the multiple forms of data using the NLU model.

8. The computer-implemented method of claim 1, wherein determining the at least one component to be replaced within the at least one device comprises ranking the multiple components based at least in part on predicted end-of-life date for each component, replacement component availability information for each component, replacement component cost information for each component, and replacement component compatibility of each component with the at least one device.

9. The computer-implemented method of claim 1, wherein obtaining multiple forms of data comprises obtaining two or more of device usage data, component usage data, user feedback data, support inspection data, device health-related data and component health-related data.

10. The computer-implemented method of claim 1, wherein performing one or more automated actions comprises automatically training at least a portion of the one or more artificial intelligence techniques based at least in part on feedback data related to the at least one component determined to be replaced within the at least one device.

11. A non-transitory processor-readable storage medium having stored therein program code of one or more software programs, wherein the program code when executed by at least one processing device causes the at least one processing device:
to obtain multiple forms of data related to at least one device and multiple components of the at least one device;
to predict, in a machine learning system, remaining lifespan-related information for at least a portion of the multiple components by processing at least a portion of the multiple forms of data, the machine learning system comprising a processing pipeline that includes a natural language understanding (NLU) model and a bi-directional recurrent neural network (RNN), with an output, comprising tokenized elements derived from the at least a portion of the multiple forms of data, of the NLU model coupled to an input of the bi-directional RNN, wherein the bi-directional RNN comprises a long short-term memory (LSTM) model implementing one or more memory units and one or more gates in the bi-directional RNN in connection with processing the tokenized elements to predict the remaining lifespan-related information;
to determine at least one of the multiple components to be replaced within the at least one device based at least in part on the predicted remaining lifespan-related information; and
to perform one or more automated actions related to automatically replacing, in connection with one or more additional systems, the at least one component determined to be replaced within the at least one device.

12. (canceled)

13. The non-transitory processor-readable storage medium of claim 11, wherein determining the at least one component to be replaced within the at least one device comprises predicting a respective end-of-life date for each of the multiple components and identifying at least one of the multiple components having the earliest end-of-life date.

14. The non-transitory processor-readable storage medium of claim 11, wherein determining the at least one component to be replaced within the at least one device comprises identifying one or more replacement component candidates for the at least one determined component to be replaced based at least in part on replacement component availability, replacement component cost and replacement component compatibility with the at least one device.

15. The non-transitory processor-readable storage medium of claim 11, wherein performing one or more automated actions comprises automatically initiating replacement of the at least one component determined to be replaced with at least one replacement component.

16. An apparatus comprising:
at least one processing device comprising a processor coupled to a memory;
the at least one processing device being configured:
to obtain multiple forms of data related to at least one device and multiple components of the at least one device;
to predict, in a machine learning system, remaining lifespan-related information for at least a portion of the multiple components by processing at least a portion of the multiple forms of data, the machine learning system comprising a processing pipeline that includes a natural language understanding (NLU) model and a bi-directional recurrent neural network (RNN), with an output, comprising tokenized elements derived from the at least a portion of the multiple forms of data, of the NLU model coupled to an input of the bi-directional RNN, wherein the bi-directional RNN comprises a long short-term memory (LSTM) model implementing one or more memory units and one or more gates in the bi-directional RNN in connection with processing the tokenized elements to predict the remaining lifespan-related information;
to determine at least one of the multiple components to be replaced within the at least one device based at least in part on the predicted remaining lifespan-related information; and
to perform one or more automated actions related to automatically replacing, in connection with one or more additional systems, the at least one component determined to be replaced within the at least one device.

17. (canceled)

18. The apparatus of claim 16, wherein determining the at least one component to be replaced within the at least one device comprises predicting a respective end-of-life date for each of the multiple components and identifying at least one of the multiple components having the earliest end-of-life date.

19. The apparatus of claim 16, wherein determining the at least one component to be replaced within the at least one device comprises identifying one or more replacement component candidates for the at least one determined component to be replaced based at least in part on replacement component availability, replacement component cost and replacement component compatibility with the at least one device.

20. The apparatus of claim 16, wherein performing one or more automated actions comprises automatically initiating replacement of the at least one component determined to be replaced with at least one replacement component.

21. The apparatus of claim 16, wherein predicting remaining lifespan-related information for the at least a portion of the multiple components comprises classifying usage associated with the at least a portion of the multiple components by processing text data from the multiple forms of data using the NLU model.

22. The apparatus of claim 16, wherein determining the at least one component to be replaced within the at least one device comprises ranking the multiple components based at least in part on predicted end-of-life date for each component, replacement component availability information for each component, replacement component cost information for each component, and replacement component compatibility of each component with the at least one device.

23. The apparatus of claim 16, wherein performing one or more automated actions comprises automatically training at least a portion of the one or more artificial intelligence techniques based at least in part on feedback data related to the at least one component determined to be replaced within the at least one device.
